(19) United States
(12) Patent Application Publication
(10) Pub. No.: US 2025/0336303 A1
(43) Pub. Date: Oct. 30, 2025

(54) SYSTEMS, APPARATUSES, METHODS, AND COMPUTER PROGRAM PRODUCTS FOR WAKE TURBULENCE AVOIDANCE

(71) Applicant: Honeywell International Inc., Charlotte, NC (US)

(72) Inventors: Kunwar Kranti, Bangalore (IN); Prabhat Kumar Bag, Bangalore (IN); George Rajan Koilpillai, Bangalore (IN); Mahboob Shariff, Bangalore (IN)

(21) Appl. No.: 19/193,366

(22) Filed: Apr. 29, 2025

(30) Foreign Application Priority Data
Apr. 30, 2024 (IN) 202411034283

(51) Int. Cl. G08G 5/34; G08G 5/32; G08G 5/52

(52) U.S. Cl. CPC G08G 5/34; G08G 5/32; G08G 5/52

(57) ABSTRACT

Various embodiments of the present disclosure provide techniques for avoiding wake turbulence during flight take-off operations and during flight landing operations. The techniques may include receiving first flight take-off operational data associated with a first flight take-off operation, the first flight take-off operational data comprising departure path data and take-off location data for the first flight take-off operation; determining, based on one or more of the departure path data or take-off location data for the first flight take-off operation, optimal flight take-off operational data for a second flight take-off operation following the first flight take-off operation, the optimal flight take-off operational data for the second flight take-off operation comprising one or more of (i) predicted departure path data or (ii) predicted take-off location data for the second flight take-off operation; and providing the optimal flight take-off operational data for performance of the second flight take-off operation.

### CROSS REFERENCE TO RELATED APPLICATIONS

This application claims priority to India application No. 202411034283, filed on Apr. 30, 2024, the contents of which are hereby incorporated herein by reference in their entirety.

### TECHNOLOGICAL FIELD

The present disclosure relates, generally, to systems, apparatuses, methods, and computer program products for wake turbulence avoidance. Example embodiments are directed to systems, apparatuses, methods, and computer program products for wake turbulence avoidance in aircraft operation environments.

### BACKGROUND

Various embodiments of the present disclosure address technical challenges related to wake turbulence in aircraft operation environments. Through applied effort, ingenuity, and innovation, Applicant has solved problems related to wake turbulence in aircraft operation environments by developing solutions embodied in the present disclosure, which are described in detail below.

### BRIEF SUMMARY

In general, embodiments of the present disclosure provide systems, apparatuses, methods, and computer program products for wake turbulence avoidance.

In accordance with an aspect of the disclosure a computer-implemented method for wake turbulence avoidance during flight take-off operation is provided. In an example embodiments, the computer-implemented method comprises receiving first flight take-off operational data associated with a first flight take-off operation, the first flight take-off operational data comprising departure path data and take-off location data for the first flight take-off operation; determining, based on one or more of the departure path data or take-off location data for the first flight take-off operation, optimal flight take-off operational data for a second flight take-off operation following the first flight take-off operation, the optimal flight take-off operational data for the second flight take-off operation comprising one or more of (i) predicted departure path data or (ii) predicted take-off location data for the second flight take-off operation, wherein the optimal flight take-off operational data is configured to avoid wake turbulence created by the first flight take-off operation; and providing the optimal flight take-off operational data for performance of the second flight take-off operation.

In accordance with another aspect of the disclosure a computer-implemented method for wake turbulence avoidance during flight landing operation is provided. In some embodiments, the computer-implemented method comprises receiving a first flight landing operational data associated with a first flight landing operation, the first flight landing operational data comprising landing path data and landing location data for the first flight landing operation; determining, based on one or more of the landing path data or landing location data for the first flight landing operation, optimal flight landing operational data for a second flight landing operation following the first flight landing operation, the optimal flight landing operational data for the second flight landing operation comprising one or more of (i) predicted landing path data or (ii) predicted landing location data for the second flight landing operation, wherein the optimal flight landing operational data is configured to avoid wake turbulence created by the first flight landing operation; and providing the optimal flight landing operational data for performance of the second flight landing operation.

In accordance with another aspect of the disclosure, a computing system for wake turbulence avoidance during flight take-off operation is provided. In some embodiments, the computing system comprises memory and one or more processors communicatively coupled to the memory, the one or more processors configured to receive first flight take-off operational data associated with a first flight take-off operation, the first flight take-off operational data comprising departure path data and take-off location data for the first flight take-off operation; determine, based on one or more of the departure path data or take-off location data for the first flight take-off operation, optimal flight take-off operational data for a second flight take-off operation following the first flight take-off operation, the optimal flight take-off operational data for the second flight take-off operation comprising one or more of (i) predicted departure path data or (ii) predicted take-off location data for the second flight take-off operation, wherein the optimal flight take-off operational data is configured to avoid wake turbulence created by the first flight take-off operation; and provide the optimal flight take-off operational data for performance of the second flight take-off operation.

It should be appreciated that any and/or all aspects and/or operations of the example computer-implemented methods described herein may be combinable with any other of the aspects and/or operations of any other of the example computer-implemented methods described herein.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures for wake turbulence avoidance with respect to a flight take-off operation in accordance with some embodiments discussed herein.

FIG. 5 is a dataflow diagram showing example data structures for wake turbulence avoidance with respect to a flight landing operation in accordance with some embodiments discussed herein.

FIG. 6 is an operational example of an environment within which example embodiments of the present disclosure may be utilized.

FIG. 7 is a flowchart diagram of an example process for wake turbulence avoidance with respect to a flight take-off operation in accordance with some embodiments discussed herein.

FIG. 8 is a flowchart diagram of an example process for wake turbulence avoidance with respect to a flight take-off operation in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### Overview and Technical Improvements

Example embodiments disclosed herein address technical challenges associated with wake turbulence avoidance turbulence during aircraft flight take-off and landing. Aircrafts produce wake turbulence (e.g., wingtip vortices, wake vortices). Wake turbulence/vortices are formed when an airfoil is producing a lift. A lift is generated by the creation of a pressure differential over the wing surfaces. The lowest pressure occurs over the upper surface of the wing and the highest pressure is formed under the wing. Air generally moves towards the area of lower pressure. This causes it to move outwards under the wing towards the wingtip and curl up and over the upper surface of the wing, which starts the wake turbulence/vortex. A wake turbulence/vortex develops a circular motion around a core region. The core is surrounded by an outer region of the vortex, as large as 30 meters in diameter, with air moving at speeds that decreases as the distance from the core increases.

Wake turbulence/vortices may persist for about three minutes or longer, in certain conditions. A severe hazard from wake turbulence is induced roll and yaw. This is especially dangerous during takeoff and landing when there is little altitude for recovery. Aircraft with short wingspans tend to be most affected by wake turbulence. The wake turbulence affects the roll and yaw of the aircraft. Small aircraft following larger aircraft may often be displaced more than about 30 degrees in roll. Depending on the location of the trailing aircraft relative to the wave turbulence/vortices, it is common to be rolled in both directions. A significantly dangerous situation is for a small aircraft to fly directly into the wake turbulence created by a large aircraft which usually occurs while flying beneath the flight path of the large aircraft. Accordingly, a need exists for systems, apparatuses, methods, and computer program products for avoiding wake turbulence during take-off and landing of an aircraft while reducing duration between take-offs and/or reducing during between landings.

Embodiments of the present disclosure provide optimal flight operational data for a flight take-off operation that avoids wake turbulence (e.g., wake turbulence trail) created by a preceding flight take-off operation while reducing duration between the flight take-off operations. Example embodiments receive flight take-off operational data associated with a first flight take-off operation and generate an optimal flight take-off operational data for a second flight take-off operation based on the first flight take-off operational data.

Example embodiments of the present disclosure provide optimal flight operational data for a flight landing operation that avoids wake turbulence created by a preceding flight landing operation while reducing duration between the flight landing operations. Example embodiments receive operational data associated with a first flight landing operation and generate optimal flight operational data for a second flight landing operation based on the first flight landing operation.

Example embodiments in the present disclosure generate an optimal flight departure plan for a plurality of flight take-off operations based on flight configuration data associated with each flight take-off operation, wherein a wake turbulence trail is avoided for each flight take-off operation while reducing duration between flight take-off operations and/or duration between flight landing operations. For example, embodiments of the present disclosure may obviate the need to wait for a wake turbulence to clear before a next flight take-off operation or a next flight landing operation can occur.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

As used herein, the term “model” refers to a data entity that describes parameters, hyper-parameters, and/or defined operations of a rules-based algorithm, machine learning model (e.g., model including at least one or more rule-based layers, one or more layers that depend on trained parameters, coefficients, and/or the like), and/or the like. In some examples, one or more models may be configured trained, and/or the like to generate optimal flight operational data (e.g., optimal flight take-off operational data, optimal flight landing operational data). In some examples, one or more models may be trained using data associated with a plurality of historical flight operations (e.g., previous flight operations). In some examples, one or more models may include one or more supervised, unsupervised, semi supervised, reinforcement learning models, and/or the like. In some examples, one or more models may include multiple models configured to perform one or more different stages of a prediction process.

The term “machine learning model” or “ML model” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, a fuzzy-logic-based model, or the like.

A machine learning model is initially fit or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted.

The machine learning models as described herein may make use of multiple ML engines (e.g., for analysis, transformation, and other needs). The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models may be some form of neural network. The underlying ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

The ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders).

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein. The ML models herein may undergo a second or multiple subsequent training phases for retraining the models.

### EXAMPLE SYSTEMS AND APPARATUSES OF THE DISCLOSURE

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

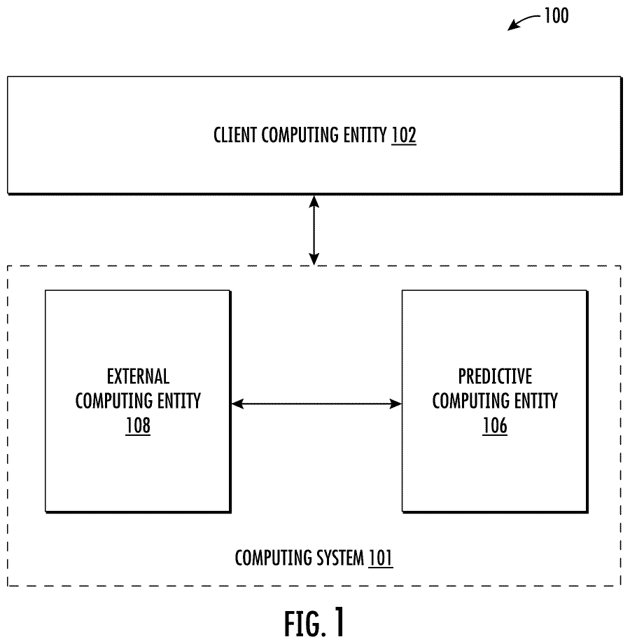

In this regard, FIG. 1 provides an example overview of an architecture 100 in accordance with some embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components.

The architecture 100 includes a computing system 101 configured to receive flight operation indications, such as a flight take-off operation indication and/or flight landing operation indication, originating from client computing entities 102, process the flight operation indications to generate optimal flight take-off operational data outputs, and provide the generated optimal flight take-off operational data outputs to the client computing entities 102. The example architecture 100 may be used in a plurality of domains and not limited to any specific application as disclosed herewith. In particular, while some example embodiments are described herein with reference to the aviation domain, the example architecture 100 may be used in a plurality of domains and not limited to any specific application as disclosed herein. The plurality of domains may include aviation, banking, healthcare, industrial, manufacturing, education, retail, to name a few.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive flight take-off operation indications from client computing entities 102, process the flight take-off operation indications to generate outputs, such as optimal operational data for flight take-off operations, and provide the generated outputs to the client computing entities 102. Alternatively, or additionally, the predictive computing entity 106 and/or one or more external computing entities 108 may be individually and/or collectively configured to receive flight landing operation indications from client computing entities 102, process the flight landing operation indications to generate outputs, such as optimal operational data for flight landing operations, and provide the generated outputs to the client computing entities 102.

In some embodiments, the predictive computing entity 106 and/or one or more external computing entities 108 comprise storage subsystems that may be configured to store input data such as operational data received from client computing entities, that may be used by the predictive computing entity 106 and/or one or more external computing entities to perform predictive data analysis of the present disclosure. In addition, the storage subsystems may be configured to store model definition data used by the respective computing entities to perform various predictive data analysis. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein.

In some example embodiments, the predictive computing entity 106 may be configured to receive and/or transmit one or more datasets, objects, and/or the like from and/or to the external computing entities 108 to perform one or more steps/operations of one or more techniques. In some embodiments, the computing system 101 may not include the external computing entities 108.

### A. Example Predictive Computing Entity

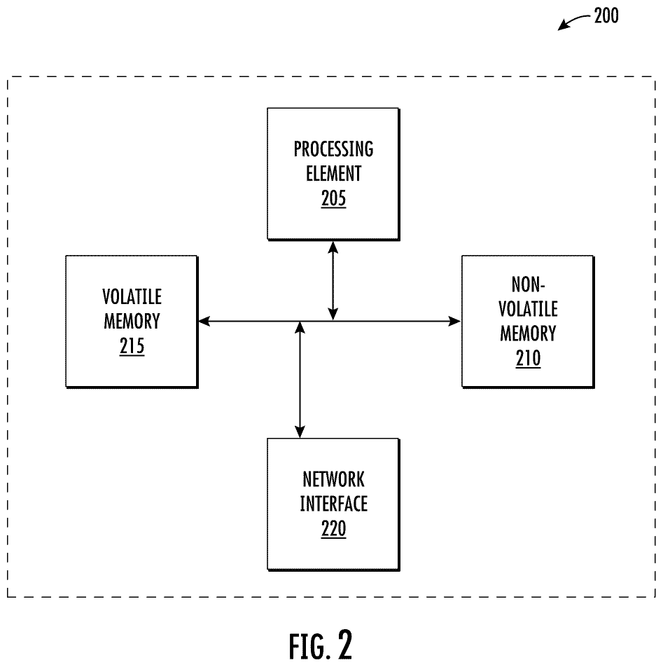

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

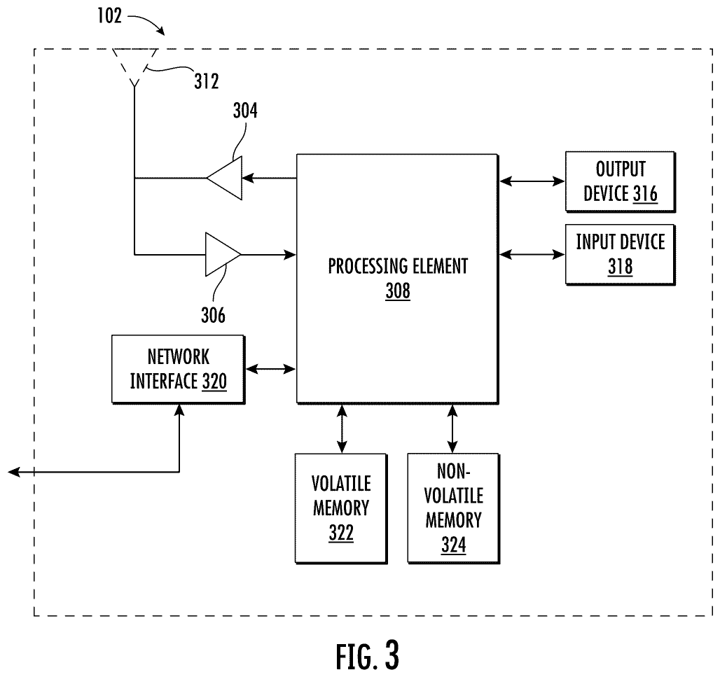

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example System Operations

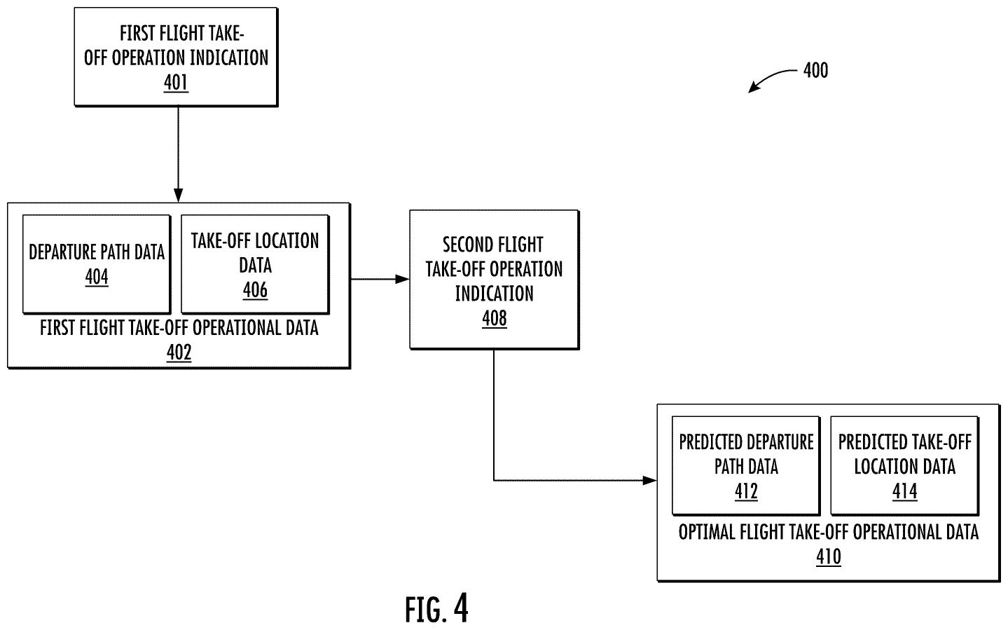

FIG. 4 is a dataflow diagram 400 showing example data structures for wake turbulence avoidance with respect to a flight take-off operation. Specifically, FIG. 4 provides a dataflow diagram 400 showing example data structures for generating optimal flight take-off operational data for a flight take-off operation configured to avoid wake turbulence created by a preceding flight take-off operation (e.g., a flight take-off operation that occurred before the particular flight take-off operation for which an optimal flight take-off operation data is being generated). In some embodiments, the preceding flight take-off operation may include an immediately preceding flight operation.

In some embodiments, a first flight take-off operational data 402 associated with a first flight take-off operation is received. In some embodiments, a flight take-off operation is the process of an aircraft lifting off from the ground (e.g., leaving the ground) and becoming airborne. A flight take-off operation may occur on a runway. Departure path and take-off location may be selected to facilitate a flight take-off operation.

In some embodiments, the first flight take-off operational data 402 is received from a client computing entity associated with the first flight take-off operation. For example, the first flight take-off operational data 402 may be received from a client computing entity onboard an aircraft associated with the first flight take off operation. For example, the operational data may be transmitted via a client computing entity onboard an aircraft in response to certain user interaction with an aircraft system (e.g., a flight management system and/or other aircraft systems). For example, a pilot of an aircraft preparing to takeoff may select a departure path for the aircraft and identify a take-off location (e.g., rotation speed location (VR point)) for the aircraft. The pilot, via interaction with the aircraft system, may cause the first flight take-off operational data to be transmitted to the predictive computing entity 106. In some embodiments, the aircraft system may embody one or more of the components of the predictive computing entity 106, external computing entity 108, or the client computing entity 102.

In some embodiments, the first flight take-off operational data 402 comprises departure path data 404 and/or take-off location data 406 for the first flight take-off operation. For example, receiving the first flight take-off operational data 402 may comprise receiving departure path data 404 and/or take-off location data 406 for the first flight take-off operation. In some embodiments, the first flight take-off operational data 402 is stored in an operational data repository after receiving the first flight take-off operational data 402.

In some embodiments, the first flight take-off operational data 402 is received in response to a first flight take-off operation indication 401. In some embodiments, a flight take-off operation indication is data, signals, or the like indicative of a flight take-off operation. For example, a flight take-off operation indication may indicate that an aircraft is queued to take-off. In some embodiments, a flight take-off operation may indicate the next aircraft in the queue scheduled to take-off.

In some embodiments, in response to the flight take-off operation indication, a take-off operational data request is sent to the client computing entity associated with the first flight take-off operation to provide the first flight take-off operational data 402. In some embodiments, a take-off operational data request is a data entity that describes a request for take-off operational data associated with a flight take-off operation. In some embodiments, a take-off operational data request may be sent to a client computing entity associated with a flight take-off operation that is next in queue to take-off.

In some embodiments, the first flight take-off operational data 402 is received automatically from the client computing entity associated with the first flight take-off operation. For example, the first flight take-off operational data 402 may be received automatically from the client computing entity associated with the first flight take-off operation after the first flight take-off operation.

In some embodiments, the first flight take-off operational data 402 is retrieved from a flight operation repository. For example, the first flight take-off operational data 402 may be retrieved from the flight operation repository in response to a flight take-off operation indication. In some embodiments, take-off location data is the rotation speed location (VR point) for an aircraft. For example, the take-off location data may comprise the location on the runway at which the aircraft nose is caused to pitch up and leave the ground. In some embodiments, the take-off location data for the first flight take-off operation comprises a visual indicator identifier of a plurality of visual indicator identifiers. The take-off location data may comprise data that may be leveraged to identify the VR point for an aircraft.

A visual indicator may describe lights, such as runway edge lights, located at and/or towards the end of a runway. In some embodiments, a visual indicator identifier is one or more items or elements by which a visual indicator may be uniquely identified from other visual indicators. A visual indicator identifier may be in the form of text string(s), numerical character(s), alphabetical character(s), alphanumeric code(s), American Standard Code for information Interchange (ASCII) characters(s), and/or the like. In some embodiments, a flight operation repository is a database, datastore, or the like configured for storing flight operational data received from client computing entities.

In some embodiments, departure path data is a data entity that describes the path that an aircraft associated with a flight take-off operation selects to traverse to depart from a departure location (e.g., airport or the like). For example, the departure path data may include a set of maneuvers configured to facilitate safe flight take-off operations. In some examples, the departure path data may be the actual path traversed by the aircraft to depart from the departure location. In some embodiments, the departure path data may include a selected runway of one or more runways that the aircraft will depart from. Alternatively, or additionally, the departure path data may include departure path description. Alternatively, or additionally, the departure path data may include coordinate information of the path selected for the aircraft to traverse and/or that the aircraft actually traverses to land at the landing location.

In some embodiments, optimal flight take-off operational data 410 for a second flight take-off operation following the first flight take-off operation is determined based on one or more of the departure path data or take-off location data for the first flight take-off operation.

In some embodiments, the optimal flight take-off operational data 410 is determined in response to a second flight take-off operation indication 408 indicative of a second flight take-off operation in queue.

In some embodiments, optimal flight take-off operational data is flight take-off operation data that is predicted for an aircraft in queue to take-off that avoids wake turbulence created by a preceding flight take-off operation (e.g., take-off operation of an aircraft that took-off from the departure location (e.g., airport or the like) before the aircraft associated with the next flight take-off operation in queue to take-off. The preceding flight take-off operation may be the immediately preceding flight take-off operation.

In some embodiments, the optimal flight take-off operational data 410 for the second flight take-off operation comprises one or more of predicted departure path data 412 or predicted take-off location data 414 for the second flight take-off operation. In some embodiments, the optimal flight take-off operational data 410 is configured to cause the aircraft associated with the second flight take-off operation to avoid wake turbulence created by the first flight take-off operation. For example, the predicted departure path data 412 for the second flight take-off operation and the predicted take-off location data 414 for the second flight take-off operation may be individually or collectively configured to cause the aircraft associated with the second flight take-off operation to avoid the wake turbulence created by the first flight take-off operation. For example, the predicted departure path data 412 for the second flight take-off operation may be different from the departure path data 404 for the first flight take-off operation and/or the predicted take-off location data 414 may be different from the take-off location data 406 for the first flight take-off operation. The predicted take-off location data 414 for the second flight take-off operation, for example, may comprise a visual indicator identifier that is different from the first visual indicator identifier associated with the first flight take-off operation. In some embodiments, the optimal flight take-off operational data 410 is determined in response to a second flight take-off operation indication.

In some embodiments, the optimal flight take-off operational data 410 for the second flight take-off operation following the first flight take-off operation (e.g., a flight take-off operation queued to take off after the first flight take-off operation) is determined based on one or more of the departure path data or take-off location data for the first flight take-off operation by analyzing the departure path data and/or the take-off location data for the first flight take-off operation to determine an optimal flight take-off operational data 410 comprising predicted departure path data 412 and/or predicted take-off location data 414 for the second flight take-off operation that avoids the wake turbulence created by the first flight take-off operation.

The departure path data for the first flight take-off operation may be analyzed to determine a predicted departure path data 412 for the second flight take-off operation that is different from the departure data for the first flight take-off operation. Alternatively, or additionally, take-off location data for the first flight take-off operation may be analyzed to determine a predicted take-off location data for the second flight take-off operation that is different from the take-off location data for the first flight take-off operation. In this regard, a different departure path data for the second flight take-off operation or a different take-off location data for the second flight take-off operation may be configured to individually or collectively avoid the wake turbulence created by the first flight take-off operation.

In some embodiments, one or more models may be used to determine the optimal flight take-off operational data 410 for the second flight take-off operation. The departure path data and/or take-off location data for the first flight take-off operation may be input to the one or more models configured, trained, or the like to analyze the departure path data or take-off location data input to the one or more models and output an optimal flight take-off operational data 410 as described above. In some embodiments, the one or more models may include one or more machine learning models (e.g., one or more supervised, unsupervised, semi supervised, reinforcement learning models, and/or the like).

In some embodiments, analyzing the departure path data for the first flight take-off operation comprises comparing the departure path data to one or more candidate departure path data while considering one of more factors, parameters, key performance indicators (KPI), or the like such as safety KPI, weather condition, flight duration, fuel usage efficiency KPI, time between the first flight take-off operation and the second flight take-off operation KPI, aircraft configuration, or the like. In some embodiments, analyzing the take-off location data for the first flight take-off operation comprises comparing the take-off location data to one or more candidate take-off location data while considering one or more factors, parameters, key performance indicators, or the like such as safety KPI, weather condition, flight duration, fuel usage efficiency KPI, time between the first flight take-off operation and the second flight take-off operation KPI, aircraft configuration, or the like. In some embodiments, determining the optimal flight take-off operational data 410 for the second flight take-off operation comprises determining estimated wake turbulence trail (e.g., predicted wake turbulence trail) created by the first flight take-off operation based at least in part on the departure path data for the first flight take-off operation, the take-off location data for the first flight take-off operation, and/or flight configuration data for the aircraft associated with the first flight take-off operation. For example, the departure path data, the take-off location data, and/or the flight configuration data may be used to calculate the wake turbulence trail created by the first flight take-off operation. In some embodiments, a specially-configured algorithm may be applied to the departure path data, take-off location data, and the flight configuration data to calculate the wake turbulence trail created by the first flight take-off operation. Alternatively, or additionally, one or more models may be trained, configured, or the like to receive departure path data, take-off location data, and flight configuration data associated with the first flight take-off operation and output estimated wake turbulence trail created by the first flight take-off operation. The one or more models for example may include the specially-configured algorithm described above. In some embodiments, the one or more models may include one or more machine learning models (e.g., one or more supervised, unsupervised, semi supervised, reinforcement learning models, and/or the like).

In some embodiments, the flight configuration data comprises the aircraft weight. Alternatively, or additionally, in some embodiments, the flight configuration data comprises the aircraft model. Other examples of flight configuration data include aircraft body style, aircraft wing type, aircraft manufacturer, aircraft identifier, etc. In some embodiments, estimated wake turbulence trail is a data entity that describes the location of wake turbulence created by an aircraft associated with the flight take-off operation (e.g., the area having wake turbulence). The estimated wake turbulence trail, for example, may include the altitude (e.g., relative to the ground) where wake turbulence is present, shape of the wake turbulence, or otherwise the path having wake turbulence at least for an amount of time.

In some embodiments, the optimal flight take-off operational data 410 is provided for performance of the second flight take-off operation. In some embodiments, the optimal flight take-off operational data 410 is provided to a client computing entity associated with the second flight take-off operation. For example, the optimal flight take-off operational data 410 may be provided to a client computing entity onboard an aircraft associated with the second flight take off operation.

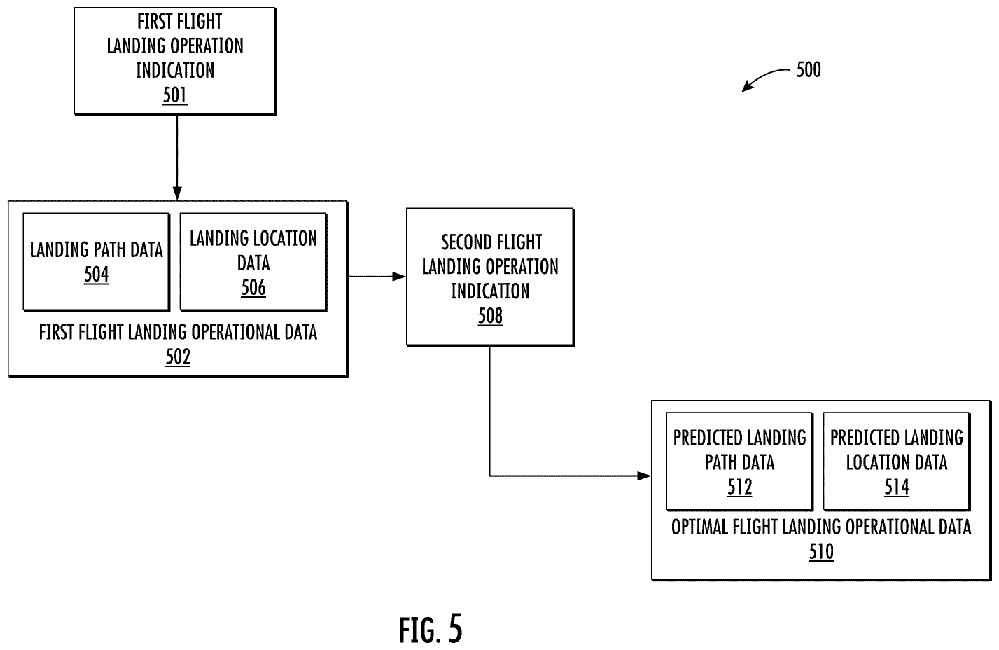

FIG. 5 is a dataflow diagram 500 showing example data structures for wake turbulence avoidance with respect to a flight landing operation. Specifically, FIG. 5 provides a dataflow diagram 500 showing example data structures for generating optimal flight landing operational data for a flight landing operation configured to avoid wake turbulence created by a preceding flight landing operation. The preceding flight landing operation may be the immediately preceding flight landing operation.

In some embodiments, a first flight landing operational data 502 associated with a first flight landing operation is received. In some embodiments, a flight landing operation is the process of an aircraft touching down on ground subsequent to being airborne. A flight landing operation may occur on a runway. A landing path and/or landing location for a flight take-off operation may be selected to facilitate a flight landing operation.

In some embodiments, the first flight landing operational data 502 is received from a client computing entity associated with the first flight landing operation. For example, the first flight landing operational data 502 may be received from a client computing entity onboard an aircraft associated with the first flight landing operation. For example, the flight landing operational data may be transmitted via a client computing entity onboard an aircraft in response to certain user interaction with an aircraft system (e.g., a flight management system and/or other aircraft systems). For example, a pilot of an aircraft preparing to land may select a landing path for the aircraft and identify a landing location (e.g., touchdown point) for the aircraft. The pilot, via interaction with the aircraft system, may cause the first flight landing operational data to be transmitted to the predictive computing entity 106.

In some embodiments, the first flight landing operational data 502 comprises landing path data 504 and/or landing location data 506 for the first flight landing operation. For example, receiving the first flight landing operational data 502 may comprise receiving landing path data 504 and/or landing location data 506 for the first flight landing operation. In some embodiments, the first flight landing operational data 502 is stored in an operational data repository after receiving the first flight landing operational data 502.

In some embodiments, landing path data is a data entity that describes the path that an aircraft associated with a flight landing operation selects to traverse to land at a landing location (e.g., airport or the like). For example, the landing path data may include a set of maneuvers configured to facilitate safe flight landing operations. In some examples, the departure path data may be the actual path traversed by the aircraft to land at the landing location. In some embodiments, the landing path data may include a selected runway of one or more runways that the aircraft will land. Alternatively, or additionally, the landing path data may include landing path description. Alternatively, or additionally, the landing path data may include coordinate information of the path selected for the aircraft to traverse to land and/or that the aircraft actually traverses to land at the landing location.

In some embodiments, landing location data is the touchdown point for an aircraft. For example, the landing location data may comprise the location on the runway at which the aircraft landing gear wheels are caused to touch the ground to land the aircraft. In some embodiments, the landing location data for the first flight landing operation comprises a visual indicator identifier of a plurality of visual indicator identifiers, as described above. The landing location data may comprise data that may be leveraged to identify the touchdown point for an aircraft.

In some embodiments, the first flight landing operational data 502 is received in response to a first flight landing operation indication 501. In some embodiments, in response to the first flight landing operation indication 501, a landing operational data request is sent to the client computing entity associated with the first flight landing operation to provide the first flight landing operational data 502. In some embodiments, a landing operational data request is a data entity that describes a request for landing operational data associated with a flight landing operation. In some embodiments, a landing operational data request may be sent to a client computing entity associated with a flight landing operation data that is next in queue to land.

In some embodiments, the first flight landing operational data 502 is received automatically from the client computing entity associated with the first flight landing operation. For example, the first flight landing operational data 502 may be received automatically from the client computing entity associated with the first flight landing operation after the first flight landing operation.

In some embodiments, the first flight landing operational data 502 is retrieved from a flight operation repository. For example, the first flight landing operational data 502 may be retrieved from the flight operation repository in response to a flight landing operation indication. In some embodiments, the landing location data for the first flight landing operation comprises a visual indicator identifier.

In some embodiments, optimal flight landing operational data 510 for a second flight landing operation following the first flight landing operation is determined based on one or more of the landing path data or landing location data for the first flight landing operation. In some embodiments, the optimal flight landing operational data 510 is generated in response to a second flight landing operation indication 508 indicative of a second flight landing operation in queue.

In some embodiments, the optimal flight landing operational data 510 for the second flight landing operation comprises one or more of predicted landing path data 512 or predicted landing location data 514 for the second flight landing operation. In some embodiments, the optimal flight landing operational data 510 is configured to cause the aircraft associated with the second flight landing operation to avoid wake turbulence created by the first flight landing operation. For example, the predicted landing path data 512 for the second flight landing operation and the predicted landing location data 514 for the second flight landing operation may be individually or collectively configured to cause the aircraft associated with the second flight landing operation to avoid the wake turbulence created by the first flight landing operation. For example, the predicted landing path data 512 for the second flight landing operation may be different from the landing path data 504 for the first flight take-off operation and/or the predicted landing location data 514 may be different from the landing location data 506 for the first flight landing operation. The predicted landing location data 514 for the second flight landing operation, for example, may comprise a visual indicator identifier that is different from the visual indicator identifier associated with the second flight landing operation. In some embodiments, the optimal flight landing operational data 510 is determined in response to a second flight landing operation indication.

In some embodiments, the optimal flight landing operational data 510 for the second flight landing operation following the first flight landing operation (e.g., a flight landing operation queued to land after the first flight landing operation) is determined based on one or more of the landing path data or landing location data for the first flight landing operation by analyzing the landing path data and/or the landing location data for the first flight landing operation to determine an optimal flight landing operational data 510 comprising predicted landing path data 512 and/or predicted landing location data 514 for the second flight landing operation that avoids the wake turbulence created by the first flight landing operation.

The landing path data for the first flight landing operation may be analyzed to determine a predicted landing path data 512 for the second flight landing operation that is different from the predicted landing path data 512 for the first flight landing operation. Alternatively, or additionally, landing location data for the first flight landing operation may be analyzed to determine a predicted landing location data 514 for the second flight landing operation that is different from the landing location data for the first flight landing operation. In this regard, a different landing path data for the second flight landing operation or a different landing location data for the second flight landing operation may be configured to individually or collectively avoid the wake turbulence created by the first flight landing operation.

In some embodiments, one or more models may be used to determine the optimal flight landing operational data 510 for the second flight landing operation. The landing path data and/or landing location data for the first flight landing operation may be input to the one or more models configured, trained, or the like to analyze the landing path data and/or landing location data input to the one or more models and output an optimal flight landing operational data 510 as described above. In some embodiments, the one or more models may include one or more machine learning models (e.g., one or more supervised, unsupervised, semi supervised, reinforcement learning models, and/or the like).

In some embodiments, analyzing the landing path data for the first flight landing operation comprises comparing the landing path data to one or more candidate landing path data while considering one of more factors, parameters, key performance indicators (KPI), or the like such as safety KPI, weather condition, flight duration, fuel usage efficiency KPI, time between the first flight landing operation and the second flight landing operation KPI, aircraft configuration, or the like. In some embodiments, analyzing the landing location data for the first flight landing operation comprises comparing the landing location data with one or more candidate landing location data while considering one or more factors, parameters, key performance indicators, or the like such as safety KPI, weather condition, flight duration, fuel usage efficiency KPI, time between the first flight landing operation and the second flight landing operation KPI, aircraft configuration, or the like.

In some embodiments, determining the optimal flight landing operational data 510 for the second flight landing operation comprises determining estimated wake turbulence trail created by the first flight landing operation based at least in part on the landing path data for the first flight landing operation, the landing location data for the first flight landing operation, and/or flight configuration data for the aircraft associated with the first flight landing operation. For example, the landing path data, the landing location data, and/or the flight configuration data may be used to calculate the wake turbulence trail created by the first flight landing operation. In some embodiments, a specially-configured algorithm may be applied to the landing path data, landing location data, and the flight configuration data to calculate the wake turbulence trail created by the first flight landing operation. Alternatively, or additionally, one or more models may be trained, configured, or the like to receive landing path data, landing location data, and flight configuration data associated with the first flight landing operation and output estimated wake turbulence trail created by the first flight landing operation. The one or more models for example may include the specially-configured algorithm described above. In some embodiments, the one or more models may include one or more machine learning models (e.g., one or more supervised, unsupervised, semi supervised, reinforcement learning models, and/or the like).

As described above, examples of flight configuration data include aircraft weight, aircraft model, aircraft body style, aircraft wing type, aircraft manufacturer, aircraft identifier, etc.

In some embodiments, the optimal flight landing operational data 510 is provided for performance of the second flight landing operation. In some embodiments, the optimal flight landing operational data 510 is provided to a client computing entity associated with the second flight landing operation. For example, the optimal flight landing operational data 510 may be provided to a client computing entity onboard an aircraft associated with the second flight landing operation.

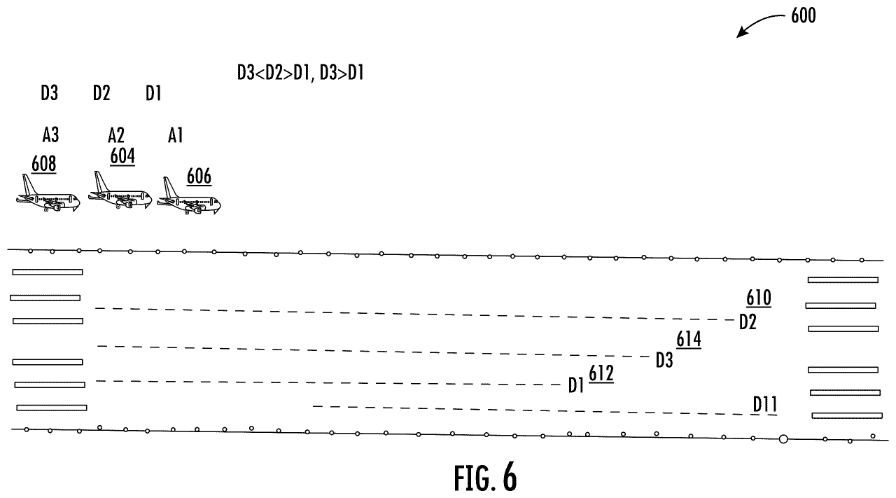

FIG. 6 is an operational example of an environment 600 within which example embodiments of the present disclosure may be utilized. As shown in FIG. 6, different sized aircraft are queued for takeoff. The mid-sized aircraft 606 (A1) is followed by a larger aircraft 604 (A2) which is followed by a smaller aircraft 608 (A3). As shown in FIG. 6, the take-off location data (e.g., VR point, and/or the like) for each aircraft is selected such that the wake turbulence created by a preceding aircraft will be avoided by an aircraft that follows the preceding aircraft. For example, the VR point 610 (D2) for the large aircraft (A1) is selected to be further down the runway (e.g., towards the end of the runway relative to VR point 612 (D1) and VR point 614 (D3) for the aircrafts 606 (A1) and aircraft 608 (A3) such that the aircrafts 606 (A1) and 608 (A3) will avoid the wake turbulence created by aircraft 604 (A2) if they take-off after aircraft 604 (A2). For example, given that aircraft 606 (A1) and aircraft 608 (A3) have VR points that are different from the VR points of aircraft 604 (A2) and will take-off at earlier (e.g., earlier VR points), their flight path leaving the runway may be below the wake turbulence created by the aircraft 604 (A2), thus avoiding the wake turbulence.

In some embodiments, an optimal flight departure plan can be generated for a plurality of flight take-off operations based on flight configuration data associated with each flight take-off operation (e.g., flight configuration data for the aircraft associated with the flight take-off operation as described above), wherein a wake turbulence trail is avoided for each flight take-off operation while reducing duration between flight take-off operations. In such embodiments, generating the optimal flight departure plan comprises identifying predicted take-off location data for each flight take-off operation based on the flight configuration data associated with the respective flight take-off operation; and assigning an order value to each flight take-off operation based on the respective predicted take-off location. For example, a predicted take-off location data for each flight take-off operation may be determined using one or more models trained, configured, and/or the like to receive the flight configuration data associated with a respective flight take-off operation and analyze or otherwise process the flight configuration data input to the one or more machine learning models to output an optimal flight departure plan that includes an order of departure for each flight operation along with predicted take-off location data for each flight take-off operation. Additionally, in some embodiments, the optimal flight departure plan may include predicted departure path data for each respective flight take-off operation.

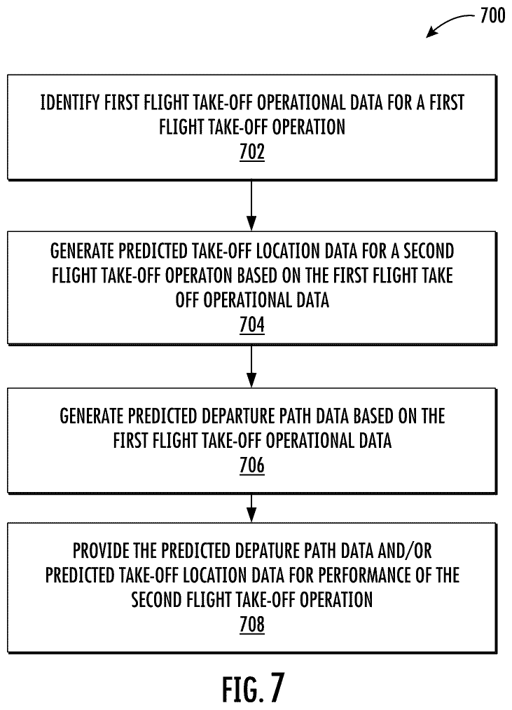

FIG. 7 is a flowchart diagram of an example process 700 for wake turbulence avoidance with respect to a flight take-off operation. The process 700 may be implemented by one or more computing devices, entities, and/or systems described herein. For example, via the various steps/operations of the process 700, the computing system 101 may generate optimal flight take-off operational data for a flight operation configured to avoid wake turbulence created by a preceding flight take-off operation.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, identifying first flight take-off operational data for a first flight take-off operation. For example, the computing system 101 may identify first flight take-off operation data for a first flight take-off operation in response to a flight take-off operation indication. In some embodiments, the first flight take-off operation data comprises departure path data for the first flight take-off operation and take-off location data for the first flight take-off operation. In some embodiments, identifying the first flight take-off operation data comprises identifying departure path data for the first flight take-off operation and/or take-off location data for the first flight take-off operation.

In some embodiments, the process 700 includes, at step/operation 704, generating predicted take-off location data for a second flight take-off operation based on the first flight take off operational data. For example, the computing system 101 may generate predicted take-off location data for the second flight take off operation based on the departure path data for the first flight take-off operation and/or take-off location data for the first flight take-off operation (e.g., as described above).

In some embodiments, the process 700 includes, at step/operation 706, generating predicted departure path data for a second flight take-off operation based on the first flight take off operational data. For example, the computing system 101may generate predicted departure path data for the second flight take off operation based on the departure path data for the first flight take-off operation and/or take-off location data for the first flight take-off operation (e.g., as described above).

In some embodiments, the process 700 includes at step/operation 708, providing the predicted departure path data and/or the predicted take-off location data for performance of the second flight take-off operation.

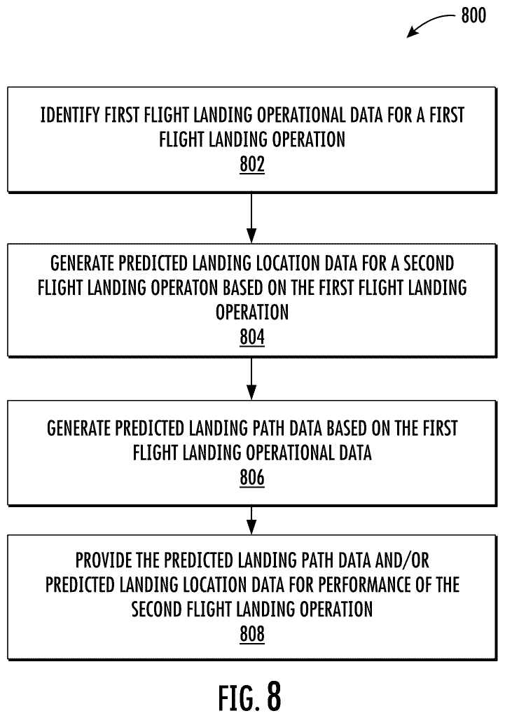

FIG. 8 is a flowchart diagram of an example process 800 for wake turbulence avoidance with respect to a flight landing operation. The process 800 may be implemented by one or more computing devices, entities, and/or systems described herein. For example, via the various steps/operations of the process 800, the computing system 101 may generate optimal flight landing operational data for a flight operation configured to avoid wake turbulence created by a preceding flight landing operation.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes, at step/operation 802, identifying first flight landing operational data for a first flight landing operation. For example, the computing system 101 may identify first flight landing operation data for a first flight landing operation in response to a flight landing operation indication. In some embodiments, the first flight landing operation data comprises landing path data for the first flight landing operation and landing location data for the first flight landing operation. In some embodiments, identifying the first flight landing operation data comprises identifying landing path data for the first flight landing operation and/or landing location data for the first flight landing operation.

In some embodiments, the process 800 includes, at step/operation 804, generating predicted landing location data for a second flight landing operation based on the first flight landing operational data. For example, the computing system 101 may generate predicted landing location data for the second flight take off operation based on the landing path data for the first flight landing operation and/or landing location data for the first flight landing operation (e.g., as described above).

In some embodiments, the process 800 includes, at step/operation 806, generating predicted landing path data for a second flight operation based on the first flight landing operational data. For example, the computing system 101may generate predicted landing path data for the second flight landing operation based on the landing path data for the first flight landing operation and/or landing location data for the first flight landing operation (e.g., as described above).

In some embodiments, the process 800 includes at step/operation 808, providing the predicted landing path data and/or the predicted landing location data for performance of the second flight landing operation.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for wake turbulence avoidance during flight take-off operation, the computer-implemented method comprising:
receiving first flight take-off operational data associated with a first flight take-off operation, the first flight take-off operational data comprising departure path data and take-off location data for the first flight take-off operation;
determining, based on one or more of the departure path data or take-off location data for the first flight take-off operation, optimal flight take-off operational data for a second flight take-off operation following the first flight take-off operation, the optimal flight take-off operational data for the second flight take-off operation comprising one or more of (i) predicted departure path data or (ii) predicted take-off location data for the second flight take-off operation, wherein the optimal flight take-off operational data is configured to avoid wake turbulence created by the first flight take-off operation; and
providing the optimal flight take-off operational data for performance of the second flight take-off operation.

2. The computer-implemented method of claim 1, wherein determining the optimal flight take-off operational data for the second flight take-off operation comprises determining estimated wake turbulence trail created by the first flight take-off operation based on one or more of the departure path data for the first flight take-off operation, the take-off location data for the first flight take-off operation, or flight configuration data for an aircraft associated with the first flight take-off operation.

3. The computer-implemented method of claim 2, wherein the flight configuration data comprises aircraft weight.

4. The computer-implemented method of claim 2, wherein the flight configuration data comprises aircraft model.

5. The computer-implemented method of claim 1, wherein the take-off location data comprises rotation speed location.

6. The computer-implemented method of claim 5, wherein the take-off location data for the first flight take-off operation comprises a visual indicator identifier corresponding to the rotation speed location.

7. The computer-implemented method of claim 1, further comprising generating an optimal flight departure plan for a plurality of flight take-off operations based on flight configuration data associated with each flight take-off operation, wherein a wake turbulence trail is avoided for each flight take-off operation while reducing duration between flight take-off operations.

8. The computer-implemented method of claim 7, wherein generating the optimal flight departure plan comprises identifying predicted take-off location data for each flight take-off operation based on the flight configuration data associated with the respective flight take-off operation; and assigning an order value to each flight take-off operation based on the respective predicted take-off location data.

9. A computer-implemented method for wake turbulence avoidance, the computer-implemented method comprising:
receiving a first flight landing operational data associated with a first flight landing operation, the first flight landing operational data comprising landing path data and landing location data for the first flight landing operation;
determining, based on one or more of the landing path data or landing location data for the first flight landing operation, optimal flight landing operational data for a second flight landing operation following the first flight landing operation, the optimal flight landing operational data for the second flight landing operation comprising one or more of (i) predicted landing path data or (ii) predicted landing location data for the second flight landing operation, wherein the optimal flight landing operational data is configured to avoid wake turbulence created by the first flight landing operation; and
providing the optimal flight landing operational data for performance of the second flight landing operation.

10. The computer-implemented method of claim 9, wherein determining the optimal flight landing operational data for the second flight landing operation comprises determining estimated wake turbulence trail created by the first flight landing operation based on one or more of the landing path data for the first flight landing operation, the landing location data for the first flight landing operation, or flight configuration data for an aircraft associated with the first flight landing operation.

11. The computer-implemented method of claim 10, wherein the flight configuration data comprises aircraft weight.

12. The computer-implemented method of claim 10, wherein the flight configuration data comprises aircraft model.

13. A computing system comprising memory and one or more processors communicatively coupled to the memory, the one or more processors configured to:
receive first flight take-off operational data associated with a first flight take-off operation, the first flight take-off operational data comprising departure path data and take-off location data for the first flight take-off operation;
determine, based on one or more of the departure path data or take-off location data for the first flight take-off operation, optimal flight take-off operational data for a second flight take-off operation following the first flight take-off operation, the optimal flight take-off operational data for the second flight take-off operation comprising one or more of (i) predicted departure path data or (ii) predicted take-off location data for the second flight take-off operation, wherein the optimal flight take-off operational data is configured to avoid wake turbulence created by the first flight take-off operation; and
provide the optimal flight take-off operational data for performance of the second flight take-off operation.

14. The computing system of claim 13, wherein the one or more processors are further configured to determine the optimal flight take-off operational data for the second flight take-off operation by determining estimated wake turbulence trail created by the first flight take-off operation based on one or more of the departure path data for the first flight take-off operation, the take-off location data for the first flight take-off operation, or flight configuration data for an aircraft associated with the first flight take-off operation.

15. The computing system of claim 14, wherein the flight configuration data comprises aircraft weight.

16. The computing system of claim 14, wherein the flight configuration data comprises aircraft model.

17. The computing system of claim 13, wherein the take-off location data comprises rotation speed location.

18. The computing system of claim 17, wherein the take-off location data for the first flight take-off operation comprises a visual indicator identifier corresponding to the rotation speed location.

19. The computing system of claim 13, wherein the one or more processors are further configured to generate an optimal flight departure plan for a plurality of flight take-off operations based on flight configuration data associated with each flight take-off operation, wherein a wake turbulence trail is avoided for each flight take-off operation while reducing duration between flight take-off operations.

20. The computing system of claim 19, wherein the one or more processors are further configured to generate the optimal flight departure plan comprises identifying predicted take-off location data for each flight take-off operation based on the flight configuration data associated with the respective flight take-off operation; and assigning an order value to each flight take-off operation based on the respective predicted take-off location.
